(19) United States
(12) Patent Application Publication
(10) Pub. No.: US 2024/0242184 A1
(43) Pub. Date: Jul. 18, 2024

(54) MACHINE LEARNING ENSEMBLE FOR PROCESSING DIVERGENT INPUT DOMAINS FOR AUTOMATED SCHEDULING SYSTEMS

(71) Applicant: Intuit Inc., Mountain View, CA (US)

(72) Inventors: Julia H. Williams, Mountain View, CA (US); Andrew Vaughan, Atlanta, GA (US); Luis Enrique Castro, Mountain View, CA (US); Ash Phllips Griffin, Steamboat Springs, CO (US)

(73) Assignee: Intuit Inc., Mountain View, CA (US)

(21) Appl. No.: 18/155,726

(22) Filed: Jan. 17, 2023

(51) Int. Cl. G06Q 10/1093; G06N 20/00

(52) U.S. Cl. CPC G06Q 10/1093; G06N 20/00

(57) ABSTRACT

A method including receiving a selected domain from a set of domains. The method also includes selecting, based on the selected domain, a selected machine learning model from among a set of machine learning models. Each of the machine learning models is configured to receive, as input, a dataset of past time-dependent data and generate, as output, a corresponding predicted quality measure for each of a number of time periods. The selected machine learning model is trained using training data generated for an entity corresponding to the domain. The method also includes executing the selected machine learning model on the dataset to generate predicted quality measures for the time periods. The method also includes generating, using the predicted quality measures, a schedule for executing a computer process. The method also includes presenting the schedule.

### BACKGROUND

Automated scheduling systems may be used to automatically determine when and under what circumstances automated processes are implemented. However, any given automated scheduling system may be useful only for a single domain, requiring input data specific to that domain.

### SUMMARY

The one or more embodiments include a method. The method includes receiving a selected domain from a set of domains. The method also includes selecting, based on the selected domain, a selected machine learning model from among a set of machine learning models. Each of the machine learning models is configured to receive, as input, a dataset of past time-dependent data and generate, as output, a corresponding predicted quality measure for each of a number of time periods. The selected machine learning model is trained using training data generated for an entity corresponding to the domain. The method also includes executing the selected machine learning model on the dataset to generate predicted quality measures for the time periods. The method also includes generating, using the predicted quality measures, a schedule for executing a computer process. The method also includes presenting the schedule.

The one or more embodiments include another method. The method includes transmitting, from a user device over a network, an electronic request to predict a schedule for transmitting an email. The method also includes receiving, from a remote device, a calendar. The calendar includes time periods. The time periods are sub-divided into classifications. The classifications represent predicted click-through rates. The time periods are highlighted according to the classifications. The method also includes displaying the calendar on the user device.

The one or more embodiments also include a system. The system includes a processor, a network interface in communication with the processor, and a data repository in communication with the processor. The data repository stores a dataset of past time-dependent data. The data repository also stores predicted quality measures corresponding to time periods. The data repository also stores a schedule for executing a computer program. The data repository also stores a server controller executable by the processor. The server controller includes a number of machine learning models configured to receive, as input, the dataset of past time-dependent data and generate, as output, the predicted quality measures for the time periods. Each of the machine learning models is trained using a corresponding domain from a number of domains. The server controller also includes a scheduling controller programmed to generate, using at least one of the machine learning models and the predicted quality measures, the schedule for executing the computer program. The scheduling controller is also programmed to transmit the schedule via the network interface.

Other aspects will be apparent from the following description and the appended claims.

### BRIEF DESCRIPTION OF DRAWINGS

FIG. 1A and FIG. 1B show a computing system, in accordance with one or more embodiments.

FIG. 2 and FIG. 3 show flowcharts of methods, in accordance with one or more embodiments.

FIG. 4A, FIG. 4B, and FIG. 4C show an example of a use of a machine learning ensemble for processing divergent input domains for automated scheduling systems, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

In general, embodiments are directed to a machine learning ensemble for processing divergent input domains for automated scheduling systems. As explained further below, a domain is an ontologically defined grouping of entities within a category. Examples of categories may include types of business, types of medical procedures, fields of science, etc. A domain may be a grouping of entities within a category. For example, the category of “types businesses” may include the domains of “ecommerce businesses,” “retail businesses,” “legal service businesses,” and other types of business. An instance is an entity in the grouping. Thus, an instance may be a specific business within the domain. For example, “ABC company” may be an instance of the domain of “ecommerce business” with in the category of “business types.”

In machine learning, different domains may provide different contexts for automated recognition of hidden patterns in data. Thus, even if the same type of data is collected in two divergent (i.e., different) domains, a machine learning model may recognize different patterns occurring in the two different domains. However, if training data among the divergent domains is merged and used to train a single machine learning model to detect the desired patterns, then the distinguishing hidden patterns among the different domains may not be detected by the single machine learning model.

For example, consider the scenario of click-through data (i.e., the number of clicks received after an email having a hyperlink is set to many recipients) being collected for two different business domains (e.g., “ecommerce” and “legal services”). In this scenario, a single machine learning model trained on an aggregation of past click-through data from both domains may produce a different prediction on future click-through rates than two machine learning models that are separately trained on separate training data sets, one for each domain.

Thus, a technical challenge arises regarding how to generate accurate predictions using machine learning models operating on datasets from different domains, particularly when the datasets appear superficially to be the same type of information. Continuing the example, the technical challenge may be generating accurate predictions of future click-through rates for emails generated by businesses in different domains, particularly when the underlying data for both domains describe only past click-through rates.

The one or more embodiments present a technical solution to the above-described technical challenge. In particular, a determination is made, or a selection is received, regarding a selected domain that applies to the data of interest. A machine learning model, among an ensemble of machine learning models, is selected according to the selected domain. Each machine learning model in the ensemble, including the selected machine learning model, is trained on training data that is taken from the corresponding domain. The selected machine learning model generates, using the data of interest, a predicted quality measure. The predicted quality measure is used to generate an automated result.

For example, in a practical application, a selected domain is received. A machine learning model is selected based on the selected domain. The selected machine learning model is trained on training data taken from the selected domain. The selected machine learning model takes the data of interest as input, and generates one or more quality measures as output. Then, an automated schedule for executing a computer process may be generated based on the one or more quality measures. The automated schedule then may be presented.

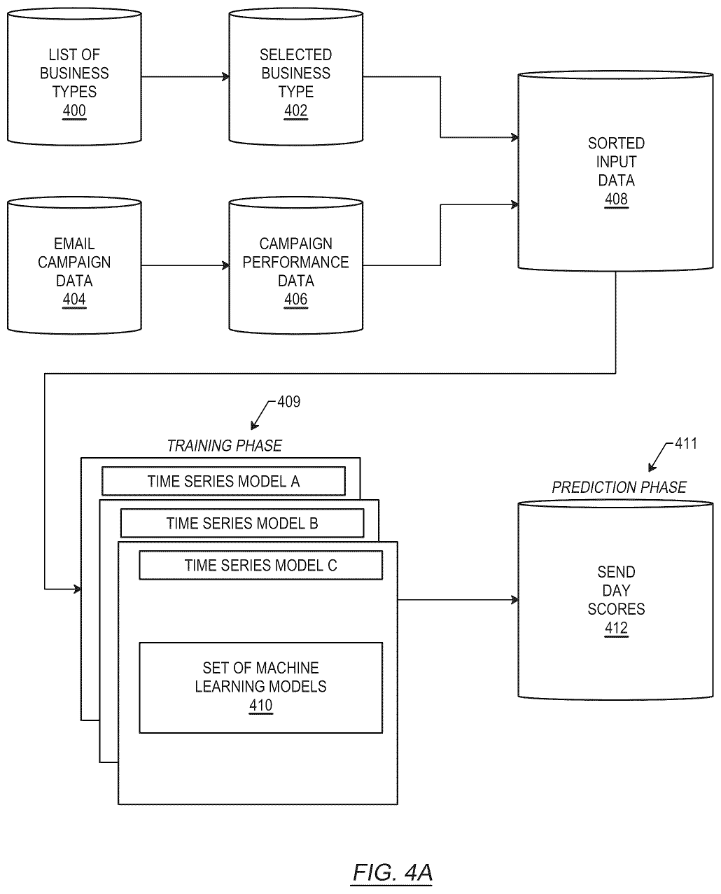

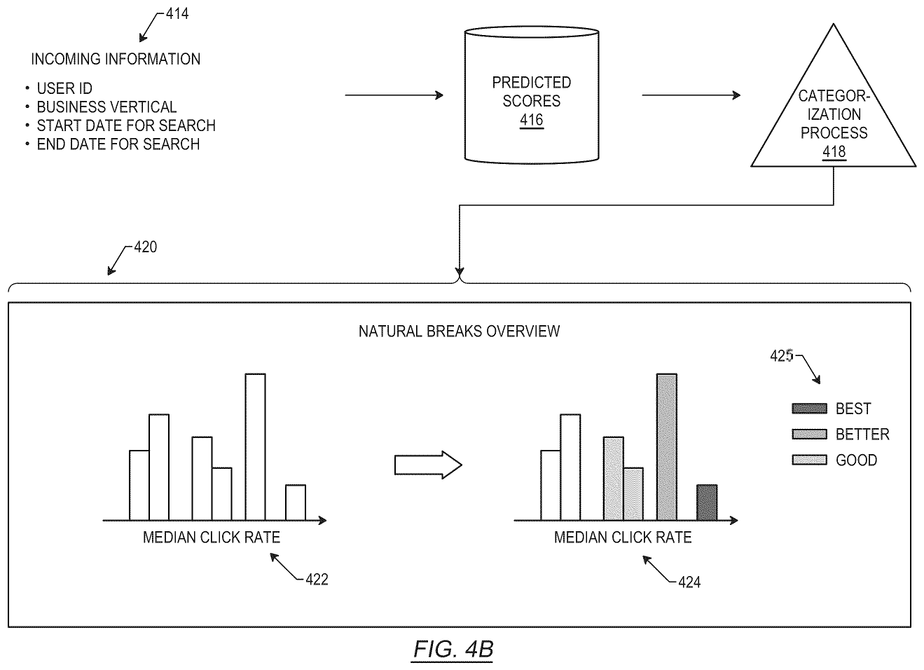

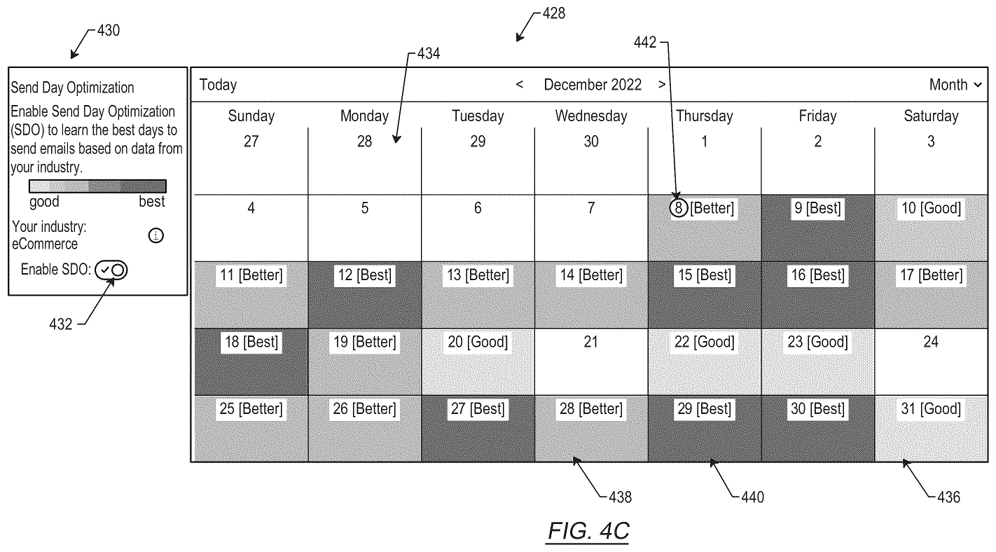

For example, an automated email scheduling system may determine the best days to send an email. In another example, an automated calendaring system may determine the best dates and times to schedule an automated teleconference among different users and computing systems. Another specific example of this process is shown in FIG. 4A through FIG. 4C.

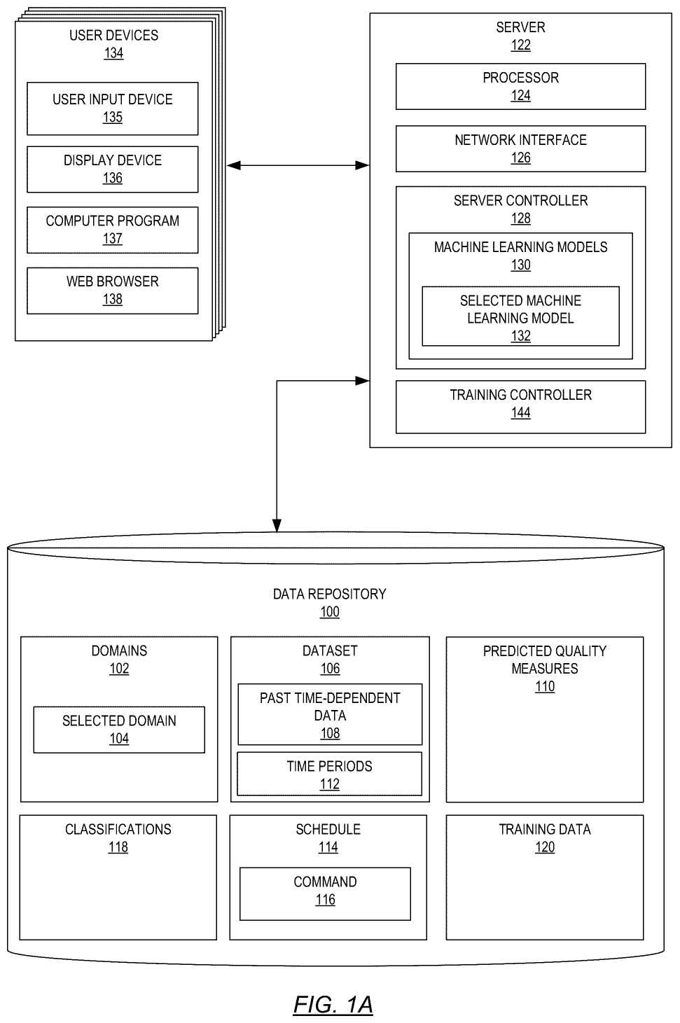

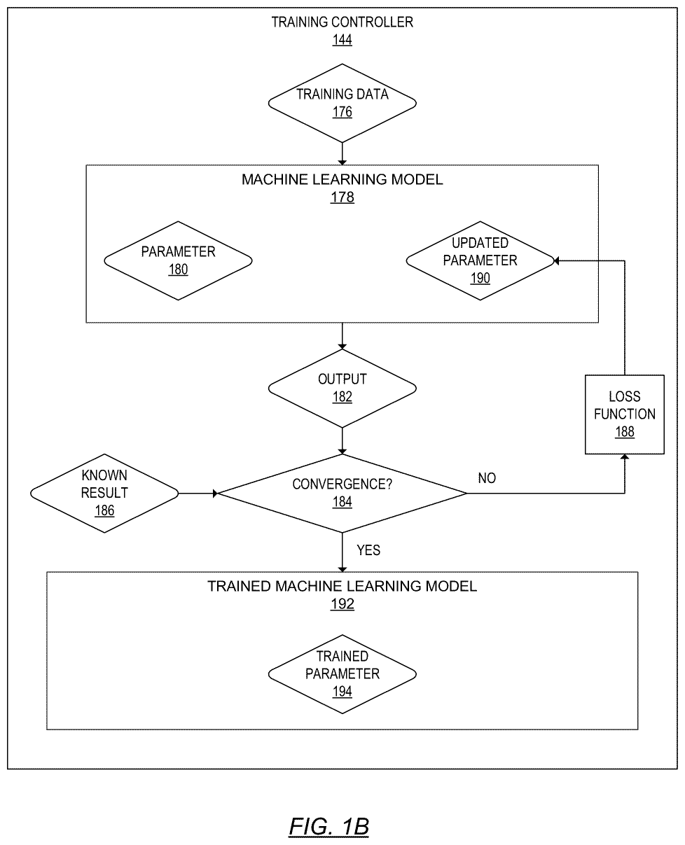

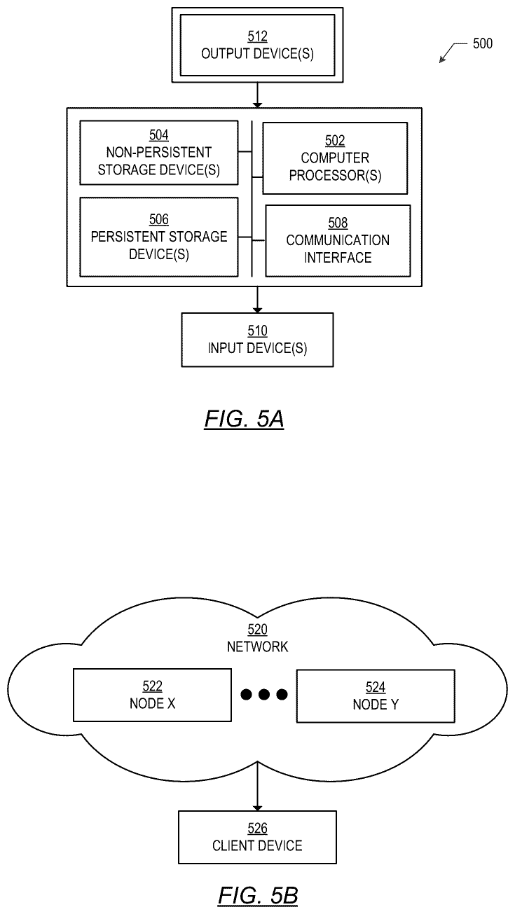

Attention is now turned to the figures. FIG. 1A and FIG. 1B show a computing system, in accordance with one or more embodiments. The system shown in FIG. 1A and FIG. 1B may be embodied as a computing system, such as shown in FIG. 5A.

In one or more embodiments, a data repository (100) may be a type of storage unit or device (e.g., a file system, database, data structure, or any other storage mechanism) for storing data. Further, the data repository (100) may include multiple different, potentially heterogeneous, storage units or devices.

The data repository (100) stores a number of domains (102). Each domain in the domains (102) is stored as a data structure that defines an organizational grouping.

As mentioned above, a domain is an ontologically defined grouping of entities within a category. Examples of categories may include types of business, types of medical procedures, fields of science, etc. A domain may be a grouping of entities within a category, with an instance being an entity in the grouping. For example, the category of “types businesses” may include the domains of “ecommerce businesses,” “retail businesses,” “legal service businesses,” and other types of business. An instance would be a specific business within the domain of “retail businesses,” such as for example “ABC company.”

Domains within a category may be related, but different. For example, a first organization may organize the category of “types of businesses” differently than a second organization. Thus, for example, a first organization may define the “ecommerce” business domain differently than a second organization. For the purposes of the one or more embodiments, a related domain may be treated as a different domain.

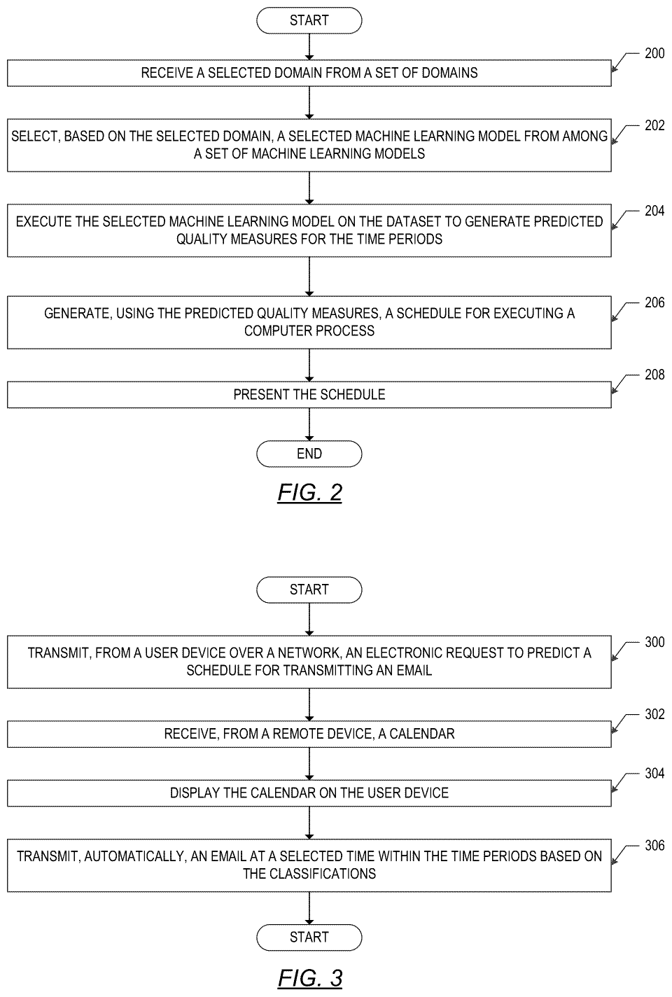

The data repository (100) also stores a selected domain (104). The selected domain (104) is one of the domains (102). Specifically, the selected domain (104) is selected by a user or by an automated process from among the domains (102). Selection of the selected domain (104) is described with respect to FIG. 2.

The data repository (100) also stores a dataset (106). The dataset (106) is data stored in a data structure that describes information of interest.

For example, the dataset (106) may include past time-dependent data (108). The past time-dependent data (108) is data representing known past events that depend on or are related to a time period (112), and more specifically is at least a data item that includes an attribute of a past event and a timestamp of when the event occurred. For example, the past time-dependent data (108) may be click-through information relating to past emails transmitted on different days within a plurality of years. Each day represents one instance of the time periods (112) (i.e., the time periods are days). Thus, the click-through information may be collected on a daily basis over the period of one or more years, and sorted by day. The click-through information describes how many clicks were received on a given day. Each click represents an email recipient clicking on a hyperlink contained in an email that was transmitted by a user.

The dataset (106), including the past time-dependent data (108), may be unrelated to the domain. For example, the selected domain (104) may be “legal service businesses,” but the dataset (106) may describe the number of hits on a third-party website on a daily basis.

The dataset (106) also may include other types of data. The dataset (106) may include data used during pre-processing steps in a method for generating a schedule, as described with respect to FIG. 4A through FIG. 4C. The dataset (106) may include input data, such as a vector upon which a machine learning model will execute.

The data repository (100) also may store one or more predicted quality measures (110) in a data structure. The predicted quality measures (110) are data representing predictions of future results or actions. For example, the predicted quality measures (110) may be predicted click-through rates for a selected email having a selected link when the email is sent to recipients on different days. In other words, the predicted quality measures (110) are the click-through rates predicted to occur if an email containing a hyperlink is sent on a given day. In another example, the predicted quality measures (110) may be predicted chemical reaction rates. In this case, the information of interest is how the chemical reactions rates may vary over a range of different temperature, pressure, and reagent combinations.

The data repository (100) also may store a schedule (114). The schedule (114) is a data structure that represents a schedule for executing a computer program or a computer process. The schedule (114) may take the form of a graphical user interface (GUI). An example of such a GUI is shown in FIG. 4C. The schedule (114) also may take the form of a computer-readable schedule for executing the computer program. The schedule (114) also may take the form of a command (116) to a processor to execute a computer program, or a command to another program to perform a computerized process. A computer program is computer-readable executable program code.

The data repository (100) also may store one or more classifications (118). The classifications (118) represents groupings or classifications of the predicted quality measures (110). For example, the predicted quality measures (110) may represent click-through rates, in which case the classifications (118) may be “moderate,” “good,” and “best.” Each of the classifications (118) in this case represents a grouping of click-through rates within a pre-determined range of click through rates. The higher the number of click through rates, the higher the classification (e.g., the click-through rates above a pre-defined number may be classified as being in the “best” category).

The schedule (114) may display the classifications (118). For example, the time period (112) may be days, and the schedule (114) is displayed as a GUI representing a calendar. A pre-determined color coding key and text may be used to display the classifications (118) on the calendar that represents the schedule (114). An example of this arrangement is shown in FIG. 4C.

The data repository (100) also may store training data (120). The training data (120) is stored as a data structure. The training data (120) represents past instances of the quality measures. For example, the training data (120) may represent past click-through rates generated when past emails with one or more hyperlinks were sent out to third party recipients on different days.

The training data (120) may be sub-divided, categorized, or classified according to the domains (102). In other words, the training data (120) may be stored as separate data structures for each of the domains (102). Thus, for example, the training data (120) may be stored as past click-through rates for those entities that correspond to a given domain within the domains (102).

In a specific example, a first set of past click-through rates may be stored for entities within an “ecommerce” domain and a second set of past click-through rates may be stored for other entities within a “legal services” domain. Each set of past click-through rates may be used as training data for a corresponding machine learning model, as described with respect to FIG. 2.

The system shown in FIG. 1 also may include other components. For example, the system shown in FIG. 1 may include a server (122). The server (122) is one or more computing systems, possibly arranged in a distributed computing environment, such as shown in FIG. 5A and FIG. 5B.

The server (122) includes a processor (124). The processor (124) is one or more hardware processors or virtual machines, possibly arrange din a distributed computing environment. The processor may be, for example, the computer processor(s) (502) shown in FIG. 5A.

The server (122) also includes a network interface (126). The network interface (126) is one or more hardware components or software programs that operate together that permit the server (122) to communicate with distributed components of the server (122), or with one or more of the user devices described below. An example of the network interface (126) may be the communication interface (508) described with respect to FIG. 5A.

The server (122) also may include a server controller (128). The server controller (128) is one or more application specific hardware components or software programs that, when executed by the processor (124), perform a computer-implemented method. For example, the server controller (128) may execute the machine learning models (130), one or more pre-processing steps (e.g. collection of input data as shown in FIG. 4A), or generation of the schedule (e.g. as shown in FIG. 2 or FIG. 4C).

The server controller (128) includes one or more of the machine learning models (130). A machine learning model (MLM) is a computer program that has been trained to recognize certain types of patterns. Training involves establishing parameters of the MLM using a set of training data for which the output pattern is already known. Once the parameters are set, the MLM may be provided with new data for which the output pattern is not known. The output of the trained MLM operating on new data is one or more numbers that reflect a prediction of the types of patterns in the new data.

One use of a MLM is to automatically classify data items in a new data set. For example, a new data set may be billions of computer emails. A trained MLM may be used to automatically classify the billions of computer emails as either being undesirable malicious emails, undesirable junk emails, possibly desirable marketing emails, desirable personal emails, and desirable work-related emails. The undesirable junk emails may be sent to a junk email folder, and the undesirable malicious emails are blocked altogether. The operation of the machine learning models (130) of the one or more embodiments are described with respect to FIG. 2 and FIG. 3, with a specific example shown in FIG. 4A through FIG. 4C.

The machine learning models (130) may be of the same or different type of machine learning models. In one example, the machine learning models (130) may be the same type of machine learning model, but trained on different training data sets (e.g., different classifications of the training data (120)). Examples of specific machine learning models that may be used are described with respect to FIG. 4B.

The machine learning models (130) may include a selected machine learning model (132). The selected machine learning model (132) is one of the machine learning models (130) that has been selected for use in a particular case. Selection of the machine learning model is described with respect to FIG. 2.

The server (122) also may include a training controller (144). The training controller (144) is application specific hardware or software which, when executed by the processor (124), trains one or more of the machine learning models (130). The training controller (144) is described further with respect to FIG. 1B.

The system shown in FIG. 1 also may interact over a network with, or include, one or more user devices (134). The user devices (134) are one or more computing devices (e.g., laptop computers, desktop computers, server computers, tablets, mobile phones, etc.). The user devices (134) are operated by third party entities. For example, the user devices (134) may be computing devices which receive emails that contain hyperlinks, and thus are the sources of the click-through data described above. The user devices (134) also may be computing devices which receive the schedule (114), including possibly the command (116) which then executes on one or more of the user devices (134).

The user devices (134) may include one or more instances of a user input device (135). The user input device (135) receives input from a user. Examples of the user input device (135) include, but are not limited to, a keyboard, a mouse, a touchscreen, a microphone, etc.

The user devices (134) may include a display device (136). The display device (136) is a device for transmitting information to a user. Examples of the display device (136) include a display screen, a speaker, a haptic output device, etc. The display device (136) may display, for example, the schedule (114) or the GUI described above.

The user devices (134) may include a computer program (137). The computer program (137) is an application specific hardware or a software program which may receive the command (116) present in the schedule (114). The computer program (137) may initiate execution of a computer function on a time designated by the schedule (114). For example, the computer program (137) may be an email program, and the command (116) may cause the email program to send an email automatically according to the schedule (114).

The user devices (134) also may include a web browser (138). The web browser (138) may be a specific instance of the computer program (137), but may be an application different than the computer program (137). The web browser (138) may communicate with the server (122) via the network interface (126). The web browser (138) may display the schedule (114) in some embodiments.

Attention is now turned to FIG. 1B. FIG. 1B defines additional details with respect to the training controller (144) mentioned with respect to FIG. 1A.

Attention is turned to FIG. 1B, which shows the details of the training controller (144). The training controller (144) is a training algorithm, implemented as software or application specific hardware, that may be used to train one or more the machine learning models described with respect to FIG. 1A, including the machine learning models (130) and the selected machine learning model (132).

In general, machine learning models are trained prior to being deployed. The process of training a model, briefly, involves iteratively testing a model against test data (e.g., the training data (120) in FIG. 1A) for which the final result is known, comparing the test results against the known result, and using the comparison to adjust the model. The process is repeated until the results do not improve more than some predetermined amount, or until some other termination condition occurs. After training, the final adjusted model (i.e., the trained machine learning model (192)) is applied to the dataset (106) of FIG. 1A in order to generate the predicted quality measures (110).

In more detail, training starts with training data (176), which may be the past time-dependent data (108) described with respect to FIG. 1A. The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is a output (182), which is a prediction, a classification, a value, or some other output which the machine learning model (178) has been programmed to output.

The output (182) is provided to a convergence process (184). The convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

If convergence has not occurred (a “no” at the convergence process (184)), then a loss function (188) is generated. The loss function (188) is a program which adjusts the parameter (180) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that more closely matches the known result (186).

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194).

During deployment, the trained machine learning model (192) with the trained parameter (194) is executed again, but this time on the dataset (106) of FIG. 1A for which the final result is not known. The output of the trained machine learning model (192) is then treated as a prediction of the information of interest relative to the unknown data.

The training process described above may be tailored to the one or more embodiments. A specific example of the training process described above is presented in FIG. 4A.

While FIG. 1A and FIG. 1B show a configuration of components, other configurations may be used without departing from the scope. For example, various components may be combined to create a single component. As another example, the functionality performed by a single component may be performed by two or more components.

FIG. 2 and FIG. 3 show flowcharts of methods, in accordance with one or more embodiments. The methods shown in FIG. 2 and FIG. 3 may be performed using the system shown in FIG. 1A and FIG. 1B, possibly using components shown in FIG. 5A and FIG. 5B.

Step 200 includes receiving a selected domain from a set of domains. The domain may be received either from a user, or may be received automatically. For example a list of domains may be presented to a user. The user may select the selected from the list of domains. Alternatively, the selected domain may be received by some other process, such as from the output of the execution of automated rules, or from the output of the execution of one or more machine learning models.

Step 202 includes selecting, based on the selected domain, a selected machine learning model from among a set of machine learning models. For example, a set of two or more pre-trained machine learning models may be available for use. Each of the pre-trained machine learning models is configured to receive, as input, a dataset of past time-dependent data and generate, as output, a corresponding predicted quality measure for each of a set of time periods. An example is shown in FIG. 4A. Each of the pre-trained machine learning models, including the selected machine learning model, is trained using training data generated for an entity corresponding to the domain. Thus, the selected machine learning model is the machine learning model that has been pre-trained specifically for the domain in question (i.e., the selected domain). Again, an example is shown in FIG. 4A.

Step 206 includes executing the selected machine learning model on the dataset to generate predicted quality measures for the time periods. The selected machine learning model may be executed by one or more processors using the inputs described above. The inputs may be, for example, the results of past actions taken in the domain in question. For example, as elaborated by way of example in FIG. 4A, the results of a prior bulk email campaign performance by the particular user (in terms of the click-through rates of each day in a series of days throughout a year) may form the input. If the user has not previously preformed the past actions, then the results of past actions may be taken from other users in the same or similar domain in order to generate an approximate prediction.

The vector representation of the input may be a matrix stored as a table data structure. The matrix includes verticals, dates, and median click-through rates for the verticals during a time period, such as the past 5 years. The data may be obtained from the aggregation (median over time) queries that are previously created. The data may be used to create a table that the model (e.g. an ARIMA model) uses for prediction (i.e., the table is input to the model).

The selected machine learning model (and other machine learning models in the set) may be a time-series machine learning model, such as an ARIMA PLUS model. The selected machine learning model may include programming for performing a variety of functions. The programming may include programming for inferring the data frequency of the time series, handling irregular time intervals, and handling duplicated time stamps by taking the mean value. The programming also may include programming for interpolating missing data using local linear interpolation, detecting and cleaning spike and dip outliers in the data, and detecting adjusting abrupt step level changes in the data, and detecting and adjusting for holiday effects. The programming also may include programming for detecting multiple seasonal patterns within a single time series via seasonal and trend decomposition using loess, including extrapolating seasonality via double exponential smoothing. The programming also may include programming for detecting and modeling one or more trends using the auto ARIMA algorithm for automatic hyperparameter tuning to achieve a lowest Akaike information criterion.

One or more of the programmed functionalities described above generates a decomposed time series. The decomposed time series is aggregated into a forecasted time series. The decomposed time series is the basis for the output of the selected machine learning model. Thus, for example, as elaborated in FIG. 4A, the output may be a series of probabilities that indicate the likelihood of click-through rates, where each probability indicates the likelihood for a given day in the time series.

As indicated above, the machine learning model may be an ARIMA model or an ARIMA PLUS model. The ARIMA model may ingest data from multiple years, and may aggregate the median click-through rates by vertical or calendar date. The number of years may be, for example, five years. By using five years, the model may account for many variations due to shifting day numbers and days of the week. However, other time periods may also account for variations, depending on the specific context in which the one or more embodiments are employed. Additionally, the machine learning model may be conditioned on different historical behaviors and industry data, also depending on the specific context in which the one or more embodiments are employed. Note that the family of ARIMA models may be automatically equipped to deal with different time periods (weekly, yearly, etc.)]

In addition, the decomposed time series may be modified. For example, outliers may be excluded. Days known to generate a predicted output, days pre-selected by a user, or other criteria may be used to override the predicted output for one or more times in the time periods. Thus, for example, if the domain is “ecommerce” and the predictions output by the machine learning model indicate the probability of click through rates for each day in a year, than “Black Friday” for a given year may be treated automatically as being in a “best category.” As a result, the output of the model may be modified to be “1” (i.e., the maximum probability of 100%) for “Black Friday.” In another example, weights may be applied to the output time series, in order to favor some time periods over other time periods. Other criteria may be used to modify the forecasted time series that the selected machine learning model outputs.

If the time series output by the selected machine learning model is modified, then the modified forecasted time series is the ultimate output used for further processing. In either case, the ultimate output (i.e., the forecasted time series directly output by the selected machine learning model, or the modified forecasted time series) may be used as the set of predicted quality measures in the subsequent processing described below.

Thus, for example, the ultimate output described above forms the input for step 206. Step 206 includes generating, using the predicted quality measures, a schedule for executing a computer process.

The schedule may be generated by a number of different methods. For example, the predicted quality measures may be used to select, or eliminate, certain time periods within the set of time periods. The computer process may be executed, or execution may be delayed, for the selected or eliminated time periods.

In another example, the predicted quality measures may be sorted into sets based on numerical range. For example, predicted quality measures between 0 and 0.5 may be sorted into a first set and predicted quality measures between 0.6 and 1.0 may be sorted into a second set. The computer process may be scheduled for time periods within one of the first set and the second set. However, the computer process may be scheduled for both sets, but modified in some manner depending on whether the predicted quality measures fall within the first set or the second set. For example, the computer process may be scheduled for the first set using a first input (e.g., a first email message having first content is scheduled for transmission) and for the second set using a second input (e.g., a second email message having second content is scheduled for transmission). In still another example, different computer processes may be scheduled depending on which set corresponds to a given time period.

Yet another example of generating the schedule is shown in FIG. 4C. More particularly, generating the schedule may include presenting proposed times to send an email, such as in the form of a color-coded calendar.

Step 208 includes presenting the schedule. Presenting the schedule may include displaying the schedule to a user, storing the schedule, or using the schedule as input to some other computer process. For example, presenting the schedule may include automatically executing an email application in order to send an email at a time on the schedule. However, presenting the schedule may include displaying a calendar to a user, as shown in FIG. 4C, at which point the user may select the days on which to send the email. In yet another example, presenting the schedule may include providing the schedule to a teleconference application, which then generates times at which to generate a teleconference. Still other examples are possible.

The method of FIG. 2 may be varied, such as by adding, modifying, or removing steps. For example, take the example of when the time periods include days. In this case, generating the schedule may include classifying the predicted quality measures into classifications, and generating the schedule as a calendar of days highlighted according to the classifications. Then, presenting the schedule may include displaying the calendar of days highlighted according to the classifications. Alternatively, presenting the schedule may include transmitting, automatically, an email on a selected day of the calendar of days, where the selected day is ranked into a selected category of the plurality of classifications. The selected category may be a corresponding quality measure that is above a threshold value. The threshold value may be pre-selected, or automatically determined by some process.

In another example, the computer process is an email program. In this case, the predicted quality measures may be predicted click-through rates for a link embedded in an email sent by the email program. The domains include types of businesses and the selected domain includes a selected type of business from the types of businesses. The dataset of past time-dependent data includes click-through information relating to past emails transmitted on different days within a number of years.

Continuing the example, generating the schedule may include classifying the predicted quality measures into classifications. Generating the schedule also may include generating the schedule as a calendar of days highlighted according to a pre-defined color coding key associated with the plurality of classifications. The color coding key provides a visual cue for how the days are classified. Specifically, for example, the pre-defined color coding key may label days on the schedule between at least “good” days and “best” days, where “good” days are blue and “best” days are green. The terms “good” and “best” are nonce terms that reflect the range of probabilities selected for the corresponding category.

Attention is now turned to FIG. 3. The method of FIG. 3 is a variation of the method shown in FIG. 2. Specifically, the method of FIG. 3 is a method of the one or more embodiments taken from the perspective of a remote user, whereas the method of FIG. 2 is a method of the one or more embodiments taken from the perspective of a server which could present the schedule to the remote user. However, it is not necessarily the case that FIG. 2 and FIG. 3 are so related. For example, the method of FIG. 2 may be performed by a remote computer in some cases, and the method of FIG. 3 may be performed by a local computer in some cases.

Additionally, the method of FIG. 3 is presented as a specific example in the context of generating an email. However, the method of FIG. 3 may be applied to other embodiments, such as automatically requesting and subsequently receiving a program, or for requesting some other process which is then transmitted to a third party computing device.

Step 300 includes transmitting, from a user device over a network, an electronic request to predict a schedule for transmitting an email. For example, a user may actuate a widget displayed in a web browser. In response, the web browser generates and transmits a command to a server. The server receives the request to predict a schedule for transmitting the email.

Step 302 includes receiving, from a remote device, a calendar. The calendar includes a number of time periods. The plurality of time periods are sub-divided into classifications. The classifications represent predicted click-through rates, representing actuations of a hyperlink contained in past emails.

The time periods are highlighted according to the plurality of classifications. A more specific example of such a calendar is shown in FIG. 4C.

Step 304 includes displaying the calendar on the user device. For example, the user device may display the calendar as a graphical user interface (GUI), such as that shown in FIG. 4C. The GUI may include widgets or other functionalities. For example, the GUI may include widgets that permits a user to command the automatic generation of the email and then transmission of the email on certain days indicated on the schedule.

Step 308 includes transmitting, automatically, an email at a selected time within the time periods based on the classifications. For example, the user may generate the email using an email program, or the email may be generated automatically. The web browser used to receive and display the calendar is then programmed to integrate with the email program via an application programming interface (API). The web browser then commands the email program to schedule transmission of the email at selected times on the schedule (e.g., to send the email on the days shown as “best” on the schedule).

While the various steps in the flowcharts of FIG. 2 and FIG. 3 are presented and described sequentially, at least some of the steps may be executed in different orders, may be combined or omitted, and at least some of the steps may be executed in parallel. Furthermore, the steps may be performed actively or passively.

FIG. 4A, FIG. 4B, and FIG. 4C show an example of a use of a machine learning ensemble for processing divergent input domains for automated scheduling systems, in accordance with one or more embodiments. The example of FIG. 4A through FIG. 4C may be implemented using the system shown in FIG. 1A and FIG. 1B, and may be considered a variation of the methods shown in FIG. 2 and FIG. 3. The following example is for explanatory purposes only and not intended to limit the scope of the one or more embodiments.

FIG. 4A illustrates the overall process of generating predicted send day scores. The second day scores represent the predicted number of clicks that will be generated when an email containing a hyperlink is sent on a given day. A click represents some remote user clicking on the hyperlink. Clicks, in this case, represent the remote user selecting the hyperlink in order to view an advertisement, to activate a computer function, or to command some other computer process. A given score thus represents the predicted click-through rate for a given day. The click-through scores are represented by percentages. For example, a click-through score of 0.8 indicates that 80% of email recipients will click on the hyperlink at least once. Accordingly, continuing the example, if 1000 emails are sent, then 800 recipients will click on the hyperlink at least once.

The process begins by accessing and/or pre-processing the underlying data. The underlying data include a list of business types (400). The business types may be from a standardized list, such as that provided by a government organization, or the business types may be customized in the form of a customized list. The list of business types (400) also may be generated from underlying business data (finances, product or service descriptions, etc.) using a natural language processing machine learning model.

A selected business type (402) is selected from the list of business types (400). A user, for example, may select the selected business type (402). The selected business type (402) also may be selected as the result of an automated process, such as by the output of a machine learning model that predicts which business type among the list of business types (400) a particular business belongs.

Additionally, the underlying data includes email campaign data (404). The email campaign data (404) includes information such as copies of past emails sent, email recipients, subject lines, hyperlinks, advertisements within the emails, etc. The underlying data also includes campaign performance data (406). The campaign performance data (406) includes click-through rates, purchases attributed to a click, user reviews, etc.

The underlying data is pre-processed into sorted input data (408). The sorted input data (408) is sorted according to the list of business types (400). Thus, for example, the selected business type (402) has the email campaign data (404) and the campaign performance data (406) associated with the selected business type (402).

Additionally, the sorted input data (408) is pre-processed to convert any data into a data structure suitable for input to a machine learning model. For example, the sorted input data (408) may take the form of one or more vectors which are generated from the list of business types (400), the selected business type (402), the email campaign data (404), and the campaign performance data (406). A vector includes a set of features and a corresonding set of values for the set of features. Thus, for example, the vector may take the form of a 1×N matrix (where “N” is the number of entries for the matrix), with each entry indicating the value for a feature. The vector may also take the form of an M×N matrix, where for example “M” represents the entry for a given business type within the list of business types (400) and “N” represents the number of entries for the matrix. Other variations are also possible.

The sorted input data (408) is fed as input to a set of machine learning models during a training phase (409). During the training phase (409), each of a set of machine learning models (410) is trained in a manner similar to that shown in FIG. 1B. Each machine learning model in the set corresponds to a specified business type in the list of business types (400). Thus, each of the set of machine learning models (410) is trained separately using input data from the sorted input data (408) that corresponds to the specified business type. For example, Time Series Model A in FIG. 4A may be trained using input data from multiple specific businesses in the “ecommerce” business type, Time Series Model B may be trained using input data from multiple specific businesses in the “manufacturing” business type, and Time Series Model C may be trained using input data from multiple specific businesses in the “legal services” business type.

Thereafter, the prediction phase (411) is performed. The prediction phase (411) is performed by executing a selected machine learning model from among the time series models that were trained during the training phase (409). Accordingly, the selected machine learning model is specifically trained for the selected business type (402). The selected machine learning model may be selected by the user self-reporting the business type (e.g., interacting with a web browser widget that allows the user to select from a drop-down menu of business types). The selected machine learning model also may be automatically determined based on data that is specific to the business for which a prediction is to be performed.

The selected machine learning model takes, as input data in a vector format. The input data may include a variety of different types of data. For example, the email and hyperlink to be sent may form part of the data in the input vector. Other input may include past email campaign information for that business. Other input may include the specific products or services that are for sale. Other input may include branding information for the business. Other input may include sales information from the user, or other financial information particular to the business. Other input may come from third-party sources, such as reviews. Still other input may be available for input.

The input vector ultimately is input to the selected machine learning model, which outputs a set of send day scores (412) on a calendar. Each score represents a probability indicating the predicted percentage of clicks on a hyperlink in the email, if the email is sent on a given days on the calendar. For example, if the calendar were for a month, then the send day scores (412) would include a given score for each day in the month. If the calendar were for a year, then the send day scores (412) would include 365 scores, one for each day in the upcoming year (366 scores for a leap year).

FIG. 4B continues the example of FIG. 4A. The input data (414) is input to the selected machine learning model, which then outputs the predicted scores (416). The predicted scores (416) may be the send day scores (412) from FIG. 4A.

Next the predicted scores (416) are categorized during a categorization process (418). The categorization process (418) is shown in more detail in the callout (420) shown in FIG. 4B. The median predicted click rate (422) is shown, which each bar representing the prediction for a corresponding day. The median predicted click rate (422) for each day is then categorized into one of three categories, “good,” “better,” and “best,” as shown in legend (425).

Each day is then color-coded according to a color key. For example, if the median predicted click rate (422) for a day falls within a range of 0.0 to 0.1, then the day is not labeled, and the bar is labeled a first color. If the median predicted click rate (422) for a day falls within a range of 0.2 to 0.3, then the day is labeled as “good,” and the bar is labeled a second color. If the median predicted click rate (422) for a day falls within a range of 0.3 to 0.4, then the day is labeled as “better,” and the bar is labeled a third color. If the median predicted click rate (422) for a day falls within a range of 0.5 and above, then the day is labeled as “best,” and the bar is labeled a fourth color. However, different categorization schemes, colors, and prediction values may be used. Additionally, the ranges given above are exemplary only, and may be industry specific.

The example of FIG. 4A and FIG. 4B is continued in FIG. 4C. FIG. 4C shows an example of a graphical user interface (428), showing a calendar of the month of December 2022. The graphical user interface (428) is arranged by week and by day. The graphical user interface (428) includes a legend (430). The legend (430) may include one or more widgets, such as widget (432), for modifying the output shown in the graphical user interface (428).

The days of the month are color-coded. Days, such as day (434), that are not colored or labeled are categorized as having predicted quality scores below a lower threshold value. Days, such as day (436), that are colored a first color are labeled as “good,” and correspond to days that have predicted quality scores between a first range of threshold values that are above the lower threshold value. Days, such as day (438), that are colored a second color are labeled as “better,” and correspond to days that have predicted quality scores between a second range of threshold values that are above the first range of threshold values. Days, such as day (440), that are colored a third color are labeled as “best,” and correspond to days that have predicted quality scores between a third range of threshold values that are above the second range of threshold values.

After viewing the graphical user interface (428), a user may then decide the days on which the user would like to transmit an email for an email campaign. The user may not wish to send an email every day, as frequently sent advertising emails may be deemed undesirable by one or more of the recipients of the emails. By view multiple categories of days, the user may decide the frequency of sending emails. Note that the process of sending the emails may be automated, such as by a setting that commands the computer to send emails automatically on only days labeled as “best.”

The graphical user interface (428) may show other information. For example, additional highlighting (442) may be used to show the current day. Still other highlighting may be used to show other categories or other information, such as for example to show days that were automatically considered “best” days (e.g., all “Black Fridays” are automatically deemed “best” days, and the user may wish to know that a given Friday is a “Black Friday.”

Still other variations are possible. Thus, the one or more embodiments are not necessarily limited to the example shown in FIG. 4A through FIG. 4C.

Embodiments may be implemented on a computing system (FIG. 5A) specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504), persistent storage (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (512). The inputs may include text input, audio input, video input, etc., which may be processed and transmitted by the computing system (500) in accordance with the disclosure. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device.

Further, the output devices (512) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present raw or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method comprising:
receiving a dataset of past time-dependent data;
receiving a selected domain for the dataset, wherein:
the selected domain is selected from one of a first domain and a second domain;
the first domain and the second domain comprise ontologically defined groupings of entities within categories of data,
the dataset is in one of the categories of data,
the categories of data comprise a same type of data among the first domain and the second domain, and
the first domain is divergent from the second domain such that when training data among the first domain and the second domain is merged and used to train a single machine learning model, then a distinguishing hidden pattern in the categories of data among the first domain and the second domain are not detected by the single machine learning model;
selecting, based on the selected domain, a selected machine learning model from among a first machine learning model and a second machine learning model, wherein:
the first machine learning model and the second machine learning model are configured to receive, as input, the dataset and generate, as output, a corresponding predicted quality measure for each of a plurality of time periods,
the first machine learning model is trained using a first training data set in the first domain,
the second machine learning model is trained using a ‘set in the second domain,
selecting further comprises selecting the first machine learning model when the selected domain is the first domain, and
selecting further comprises selecting the second machine learning model when the selected domain is the second domain;
executing the selected machine learning model on the dataset to generate a plurality of predicted quality measures for the plurality of time periods, wherein the plurality of predicted quality measures is output by the selected machine learning model based on the selected domain;
generating, using the plurality of predicted quality measures, a schedule for executing a computer process; and
presenting the schedule.

2. The method of claim 1, wherein the computer process comprises an email program, and wherein presenting comprises:
presenting proposed times to send an email.

3. The method of claim 2, wherein presenting the schedule comprises automatically sending the email at a time on the schedule.

4. The method of claim 2, wherein the plurality of predicted quality measures comprises predicted click-through rates for a link embedded in the email.

5. The method of claim 1, wherein the first domain comprises data regarding a first type of business, wherein the second domain comprises data regarding a second type of business.

6. The method of claim 1, wherein the dataset of past time-dependent data comprises click-through information relating to past emails transmitted on different days within a plurality of years.

7. The method of claim 1, wherein the plurality of time periods comprises days, and wherein generating the schedule comprises:
classifying the plurality of predicted quality measures into a plurality of classifications; and
generating the schedule as a calendar of days highlighted according to the plurality of classifications.

8. The method of claim 7, wherein presenting the schedule comprises displaying the calendar of days highlighted according to the plurality of classifications.

9. The method of claim 7, further comprising:
transmitting, automatically, an email on a selected day of the calendar of days, wherein the selected day is ranked into a selected category of the plurality of classifications, the selected category comprising a corresponding quality measure that is above a threshold value.

10. The method of claim 1, wherein:
the computer process comprises an email program;
the plurality of predicted quality measures comprises predicted click-through rates for a link embedded in an email sent by the email program;
the first domain and the second domain comprise types of businesses and the selected domain comprises a selected type of business;
the dataset of past time-dependent data comprises click-through information relating to past emails transmitted on different days within a plurality of years;
generating the schedule comprises classifying the plurality of predicted quality measures into a plurality of classifications;
generating the schedule further comprises generating the schedule as a calendar of days highlighted according to a pre-defined color coding key associated with the plurality of classifications; and
the pre-defined color coding key labels days on the schedule between at least “good” days and “best” days.

11. (canceled)

12. (canceled)

13. A system comprising:
a processor;
a network interface in communication with the processor;
a data repository in communication with the processor, the data repository storing:
a dataset of past time-dependent data,
a selected domain selected from one of a first domain and a second domain, wherein:
the first domain and the second domain comprise ontologically defined groupings of entities within categories of data,
the dataset is in one of the categories of data,
the categories of data comprise a same type of data among the first domain and the second domain, and
the first domain is divergent from the second domain such that when training data among the first domain and the second domain is merged and used to train a single machine learning model, then a distinguishing hidden pattern in the categories of data among the first domain and the second domain are not detected by the single machine learning model;
a plurality of predicted quality measures corresponding to a plurality of time periods,
a schedule for executing a computer program; and
a server controller executable by the processor and comprising:
a first machine learning model and a second machine learning model each configured to receive, as input, the dataset of past time-dependent data and generate, as output, the plurality of predicted quality measures for the plurality of time periods, wherein:
the first machine learning model is trained using a first training data set in the first domain,
the second machine learning model is trained using a second data set in the second domain,
computer code which, when executed by the processor, selects the selected domain from among the first domain and the second domain,
computer code which, when executed by the processor, selects a selected machine learning model from among the first machine learning model and the second machine learning model, wherein
the first machine learning model is the selected machine learning model when the selected domain is the first domain, and
the second machine learning model is the selected machine learning model when the selected domain is the second domain,
computer code which, when executed by the processor, executes the selected machine learning model on the dataset to generate, based on the selected domain, the plurality of predicted quality measures for the plurality of time periods, and
a scheduling controller programmed to:
generate, using the plurality of predicted quality measures, the schedule for executing the computer program, and
transmit the schedule via the network interface.

14. The system of claim 13, wherein the scheduling controller is further programmed to:
program the schedule to include a command to automatically execute computer program according to the schedule.

15. The system of claim 14, wherein the computer program comprises an email program, and wherein the command is programmed to execute the email program to send an email at a time on the schedule.

16. The system of claim 15, wherein the plurality of predicted quality measures comprises predicted click-through rates for a link embedded in the email.

17. The system of claim 13, wherein the plurality of time periods comprises days, and wherein the scheduling controller is further programmed to:
rank the plurality of predicted quality measures into a plurality of classifications; and
generate the schedule as a calendar of days highlighted according to the plurality of classifications.

18. The system of claim 13, further comprising:
a training controller executable by the processor and programmed to train the first machine learning model using first training data in the first domain, and to train the second machine learning model using second training data in the second domain, wherein the first training data and the second training data both comprise known time-dependent data having known labels.

19. The system of claim 18, wherein the training controller is programmed to train the first machine learning model and the second machine learning model by:
inputting the first training data set into the first machine learning model;
inputting the second training data into the second machine learning model;
executing the first machine learning model to generate a first output;
executing the second machine learning model to generate a second output;
generating first loss function by comparing the first output to a first known result for the first training data;
generating a second loss function by comparing the second output to a second known result for the second training data;
adjusting the first machine learning model using the first loss function;
adjusting the second machine learning model using the second loss function; and
repeatedly the inputting, the executing, the generating, and the adjusting until both the first machine learning model and the second machine learning model achieve convergence.

20. The system of claim 13, wherein:
the scheduling controller is further configured to generate the schedule by classifying the plurality of predicted quality measures into a plurality of classifications,
the scheduling controller is further configured to generate the schedule as a calendar of days highlighted according to a pre-defined color coding key associated with the plurality of classifications, the pre-defined color coding key labeling days on the schedule between at least “good” days and “best” days, and
the server controller is further configured to generate the schedule as a graphical user interface that displays the schedule.
